(19) United States
(12) Patent Application Publication
(10) Pub. No.: US 2013/0073267 A1
(43) Pub. Date: Mar. 21, 2013

(54) ELECTRIC VEHICLE PERSONAL BENEFITS ANALYZER

(71) Applicants: Chris C. Gearhart, Chelsea, MI (US); Michael A. Tamor, Toledo, OH (US); Ciro A. Soto, Ann Arbor, MI (US)

(72) Inventors: Chris C. Gearhart, Chelsea, MI (US); Michael A. Tamor, Toledo, OH (US); Ciro A. Soto, Ann Arbor, MI (US)

(73) Assignee: FORD GLOBAL TECHNOLOGIES, LLC, Dearborn, MI (US)

(21) Appl. No.: 13/238,005

(22) Filed: Sep. 21, 2011

(51) Int. Cl. G06F 17/10

(52) U.S. Cl. 703/2

(57) ABSTRACT

A benefit analysis system allows a user to compare energy consumption between a first electrified vehicle and a second vehicle. A data collector receives user driving characteristics. A parameter calculation module determines a peak parameter, a width parameter, a weigh factor, a scale factor, and a frequency parameter in response to the user driving characteristics. An analyzer is responsive to the parameters from the parameter calculation module to generate respective energy consumption results for the first and second vehicles. The analyzer represents an individual trip chain distribution as a composite function including a habitual component defined by the peak parameter and the width parameter and a non-habitual component defined by the scale factor. The composite function combines the habitual component and the non-habitual component according to the weight factor. The analyzer determines the energy consumption results in response to the individual trip chain distributions.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to electrically-powered vehicles, and, more specifically, to a tool for analyzing the potential cost benefits that would be obtained by an individual driver if purchasing any particular electrified vehicle. The tool can also be used to provide guidance and recommendations on which type of electrification on the vehicle is more suited to the customer in question, such as recommending a hybrid electric over a plug-in hybrid, or a plug-in hybrid over a battery electric vehicle, etc.

Electrically-powered vehicles are becoming popular because of reduced energy costs and reduced emissions of pollutants. However, the initial costs of obtaining an electric vehicle are high compared with a combustion-powered vehicle (using a fuel such as gasoline, diesel, natural gas, propane, ethanol, hydrogen, or butanol, for example). Therefore, consumers need to be able to estimate the reduction in operating costs that they can expect to achieve by owning an electric vehicle in order to decide whether a sufficient tradeoff in costs would be achieved to justify a certain choice.

The consumer's decision is complicated by the availability of different types of electrified vehicles. A full electric or battery electric vehicle (BEV) can be plugged into the electric grid for charging the batteries which then supply all the power for driving the vehicle. A hybrid electric vehicle (HEV) combines the battery and electric drivetrain of a BEV with an internal combustion engine. The gasoline-powered engine may be used to recharge the battery or to provide motive power to the drivetrain, depending on the type of HEV. In a plug-in hybrid (PHEV), the batteries may also be recharged by connecting to the electric grid.

For a full electric vehicle, the cost of gasoline or other fuel carried on the vehicle is always zero—but the vehicle has a limited range based on its battery capacity. When there is a limited range, the consumer will want to know how often they would typically engage in a trip chain that would exceed the range. For a hybrid vehicle the range limitation is absent, but when the gasoline engine is used then the operating costs go up. In estimating the energy costs, it is necessary to estimate the frequency with which the gasoline engine would be used based on the driving distances and recharge opportunities considered over all the trip chains that the individual driver would be expected to make.

The manufacturer or seller of an electric vehicle can calculate and compare the energy usage and cost for any particular vehicle according to how the vehicle may be used. Using data from actual driving patterns or statistics from large groups of drivers, comparisons can be made between the energy consumption to be expected with different vehicles. Data can be presented to potential customers showing the comparisons based on the actual or assumed driving patterns. Regulations require labeling of energy use corresponding to certain fixed driving patterns (also known as driving cycles). However, it is difficult for an individual consumer to determine how much of an energy benefit they would obtain based on their own driving patterns over the long term.

### SUMMARY OF THE INVENTION

A statistical model of individual driving patterns is used to account for variability in day to day trip chain lengths of an individual driver. The model consists of two components: one that accounts for habitual driving behavior such as commuting and one that accounts for less predictable vehicle usage. The habitual component is modeled with normal distribution and the random component is modeled with an exponential distribution. The parameters that define the precise shape of these distributions vary from individual to individual. Values of the parameters are set in response to the answers provided by an individual to a series of specific questions relating to vehicle usage. Using the distribution with the individual parameters, typical fuel consumption and typical electrical consumption are calculated for different vehicles to be compared (e.g., PHEVs, BEV, and gas-only). Using this distribution, estimated trip chains are generated which act as the basis for calculating individualized results for total energy consumption, electrical energy consumption, gasoline or other fuel consumption, and the fraction of trip chains that could be fully electrified (i.e., no gasoline or other fuel used) for BEVs and PHEVs. These results are communicated to the potential consumers using a variety of platforms including but not limited to a spread sheet programs, Web-based calculators, and kiosks at dealerships or auto shows. Other applications of this “individual trip chain distribution generator” are possible, such as individual estimates of fuel economy based on a breakdown of city versus highway driving that is inferred from the distribution, and the number of cold-starts associated with a given accumulated travel distance.

In one aspect of the invention, a benefit analysis system is provided in which a user compares energy consumption between a first electrified vehicle and a second vehicle. A data collector receives user driving characteristics comprised of a commute distance, a commute repetition, a long-term aggregate driving distance, and a daily usage rate. A parameter calculation module receives the user driving characteristics, wherein the parameter calculation module determines a peak parameter, a width parameter, a weigh factor, a scale factor, and a frequency parameter in response to the user driving characteristics. An analyzer is responsive to the parameters from the parameter calculation module to generate respective energy consumption results for the first and second vehicles. The analyzer represents an individual trip chain distribution as a composite function including a habitual component defined by the peak parameter and the width parameter and a non-habitual component defined by the scale factor. The composite function combines the habitual component and the non-habitual component according to the weight factor. The analyzer determines the energy consumption results in response to the individual trip chain distributions.

### BRIEF DESCRIPTION OF THE DRAWINGS

FIG. 1 is a block diagram of one preferred embodiment of a benefit analysis system of the present invention.

FIG. 2 is a diagram showing one preferred apparatus for implementing the system of FIG. 1.

FIG. 3 illustrates a spreadsheet implementation of the system of FIG. 1.

FIG. 4 shows a user display according to one exemplary embodiment.

FIG. 5 is a graph showing usage data as measured for a representative driver.

FIG. 6 is a plot showing functions for modeling habitual and non-habitual elements of individual trip chains for an arbitrary driver.

FIG. 7 is a plot showing a composite function obtained by adding the functions shown in FIG. 6.

FIG. 8 is a plot showing the functions of FIGS. 6 and 7.

### DETAILED DESCRIPTION OF PREFERRED EMBODIMENTS

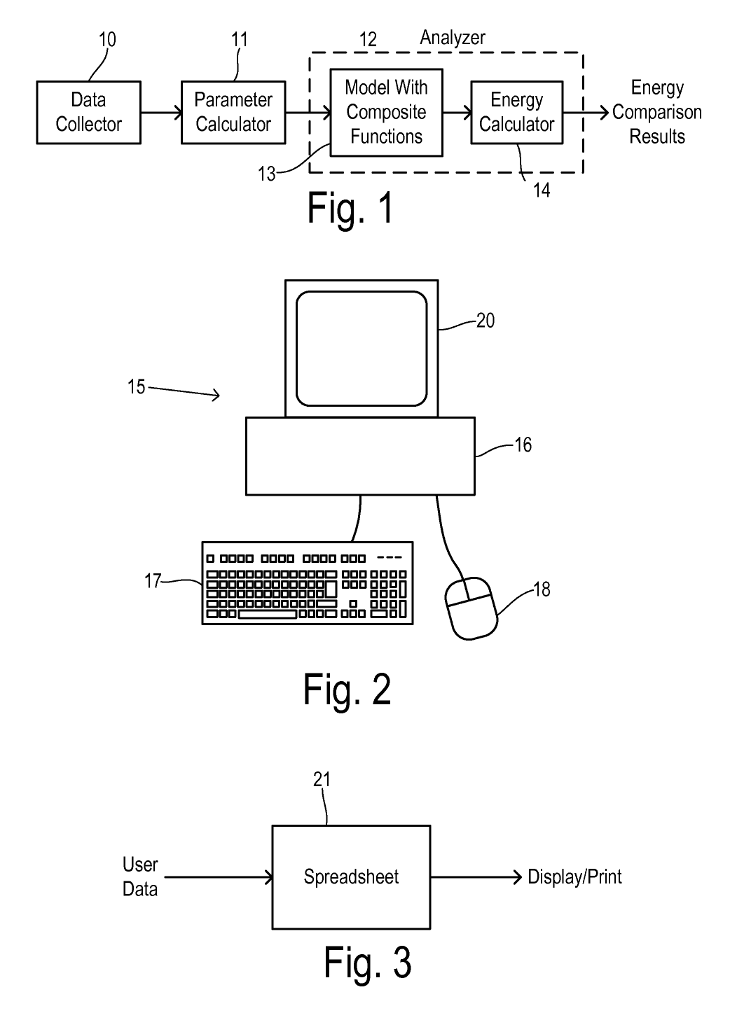

Referring now to FIG. 1, one preferred embodiment of apparatus for practicing the invention includes a data collector 10 coupled to a parameter calculator 11. An analyzer 12 receives parameters from parameter calculator 11 and generates energy comparison results and other individualized data for providing to a user such as a potential vehicle customer. Analyzer 11 includes a model 13 and an energy calculator 14. Model 13 incorporates composite functions to characterize the expected distances and frequency of driving trip chains to be made by the user as described below.

The energy comparison results preferably correspond to an individual fuel offset achieved by the individual when switching from a gasoline-powered vehicle to an electric vehicle such as a PHEV. The user inputs data into data collector 10 corresponding to the user's driving characteristics, wherein the data preferably includes a commute distance, a commute repetition, a long-term aggregate driving distance, and a daily usage rate. Parameter calculator 11 receives the user driving characteristics and determines a peak parameter, a width parameter, a weight factor, a scale factor, and a frequency parameter in response to the user driving characteristics to be used in model 13 as described below. Energy calculator 14 generates respective energy consumption results for different vehicles to be compared. Model represents an individual trip chain distribution (ITCD) as a composite function including a habitual component defined by the peak parameter and the width parameter, and a non-habitual component defined by the scale factor. The composite function combines the habitual component and the non-habitual component according to the weight factor. Energy calculator 14 determines energy consumption results in response to the individual trip chain distributions.

As shown in FIG. 2, a standard personal computer can be employed to implement the functions shown in FIG. 1. Thus, a computer 15 includes CPU 16, keyboard 17, mouse 18, and display monitor 20. Data collection is performed via keyboard 17 and mouse 18. Parameter calculation, modeling, and energy calculations are performed within CPU 16, and the energy comparison results are displayed on monitor 20. As shown in FIG. 3, the invention may be implemented as a spreadsheet 21 which receives user data as an input and provides displayed or printed energy comparison results as an output. Many other types of hardware and/or software could also be used to implement the invention, such as a smart phone, tablet, or a dedicated electronic device which can execute an analysis described below.

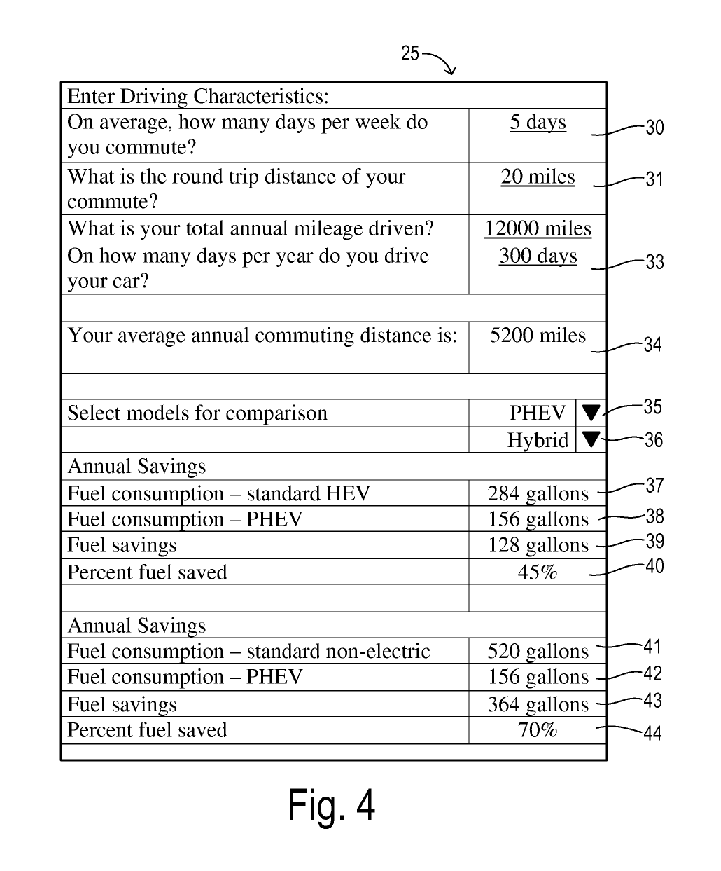

A screen display according to one example embodiment is shown in FIG. 4. A spreadsheet window 25 includes a plurality of cells for containing textual and numeric data. In a cell 30, the user enters numeric information in response to the question “on average, how many days per week do you commute?” In a cell 31, the user enters a numeric answer in response to the question “what is the round trip distance of your commute?” In response to the question “what is your total annual mileage driven”, the user enters a numeric answer in a cell 32. In a cell 33, the user enters their estimate of the number of days per year they drive their car. The spreadsheet calculates the user's average annual commuting distance by multiplying the number of days per week from cell 30 times the number of miles from cell 31 times the number of weeks in a year, and displays the result in cell 34. This information serves as a cross-check for the user to help ensure that the data they have input is self-consistent.

Cells 35 and 36 include pull down lists allowing the user to select electric vehicle models to be analyzed in the energy comparison. In the example shown, the user has selected a plug-in hybrid and a non-plug-in hybrid for comparison.

The spreadsheet employs a model and associated calculations described in more detail below in order to determine a fuel consumption for the standard hybrid in cell 37 and fuel consumption for the plug-in hybrid in cell 38. The difference in fuel consumption yields a fuel savings value that is displayed in cell 39. The savings shown as a percentage is displayed in cell 40.

Additional information and/or comparisons may be automatically calculated and displayed in the spreadsheet, such as a comparison between the selected plug-in hybrid and a non-electric vehicle of comparable body style. Thus, based on the user's driving characteristics, fuel consumption for a gasoline-powered vehicle is shown in cell 41. Fuel consumption by the PHEV and the relative fuel savings compared to the non-electric vehicle are shown in cells 42-44. Based on the user driving characteristics, other calculated information such as an estimate of the frequency of days when the driven distance exceeds the electric range of the vehicle (i.e., days of operation which are not fully electrified for all trip chains) or other calculations such as the cost of electrical energy usage for recharging can be shown. Interactive features could also be employed wherein the user could tweak their answers (e.g., to discover how a different commute distance would impact the energy results). Such a sensitivity analysis could also be provided automatically.

Although a direct vehicle-to-vehicle comparison is shown for two vehicles selected by a user, the invention could also automatically generate a comparison between a larger group of vehicles that may be of potential interest to the user. For example, the comparison could compare a “base” vehicle (e.g., a non-hybrid gasoline vehicle of a certain size) to all electric and/or hybrid vehicles of the same or similar size).

The model of the present invention employs the concept of an individual trip chain distribution (ITCD), which is a measure of how far the vehicle is driven between charging opportunities. Thus, a trip chain may include a plurality of actual “trips” in which the user starts up, drives to a destination, leaves the vehicle, re-enters the vehicle, and drives to yet another destination (i.e., the trip chain includes more than one driving event such that the trip chain begins and ends at a re-charging opportunity). For example, on any particular day between various recharging opportunities, a user may commute to work and back home and/or venture out on a shopping or other trip. A charging opportunity may be any occurrence when the vehicle is parked for at least a predetermined minimum time such as four hours at home or other location where an electric power source for recharging is available. While a trip chain may usually be completed in a 24 hour period, there could also be times when the driver has additional charging opportunities so that there would be more than one trip chain in a particular day.

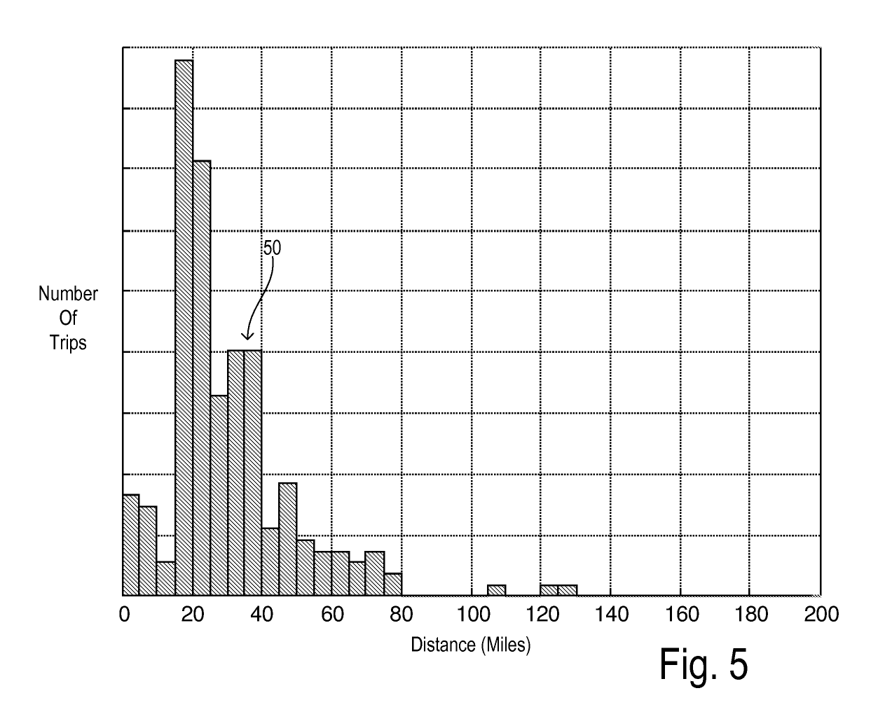

The model of the present invention is derived, in part, based on a detailed data set collected over a large number of drivers over a large fraction of a year. Trip distance data for one sample driver is shown in FIG. 5. The number of trip chains taken by this particular driver over the sample period at predefined ranges of trip distance and miles is shown by bars 50. Each bar 50 shows the total number of trip chains having the corresponding total driving distance between charging opportunities. Based on an analysis of data for a large number of drivers, it was found that a peak typically occurs corresponding to the users' normal commute distance due to the habitual nature of the commute. In addition, non-habitual trips exhibit trip-chain distributions that occur most frequently at the lower distances, with decreasing frequency at higher distances. By aggregating all trip-chain distributions for an entire sample population, it has been possible to determine the overall potential benefit of adopting various electric vehicle technologies. However, in assessing any individual user without specifically sampling their own ITCDs, there was previously no way to tell how much of an individual driver's vehicle usage could be characterized habitual and how much as non-habitual. The present invention characterizes the proportion of habitual to non-habitual driving based on the four questions asked of the user in FIG. 4.

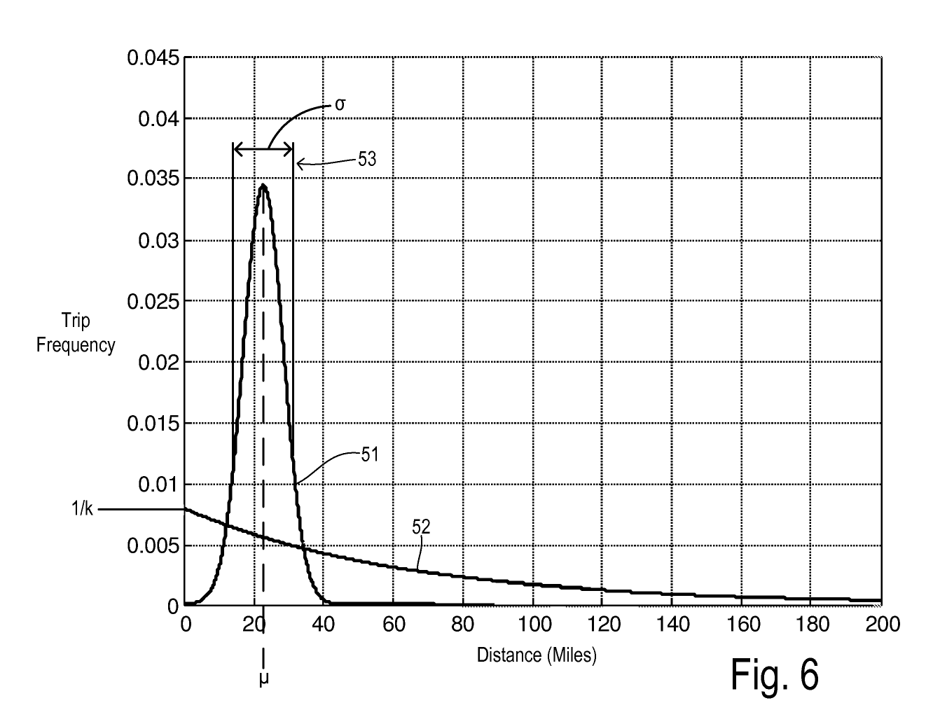

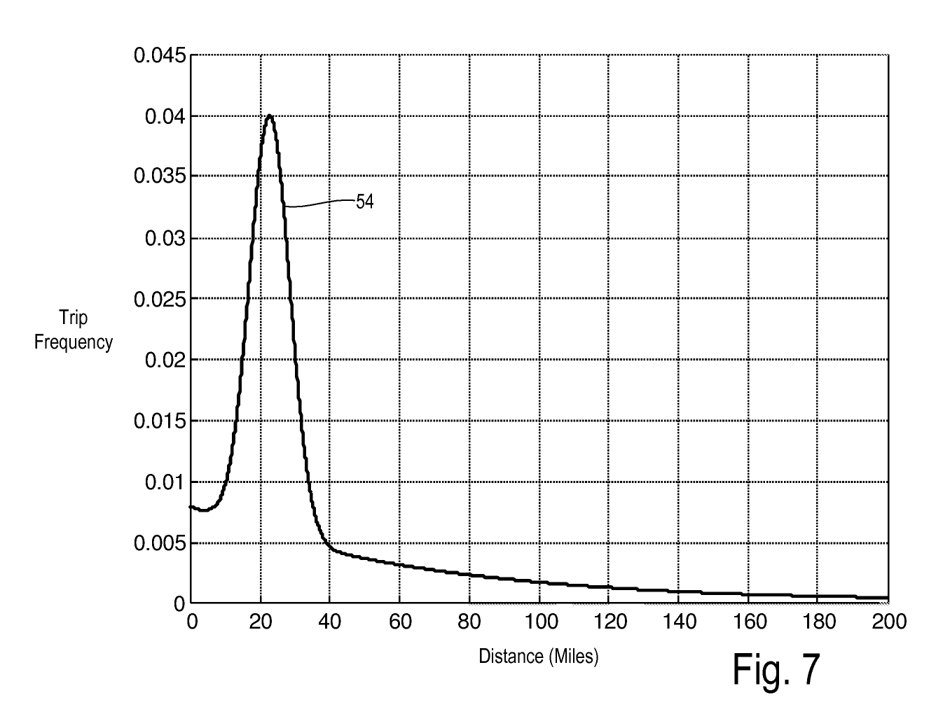

The present invention represents individual trip chain distributions for each individual driver as a composite function with a habitual component preferably having a “peaked” distribution and a non-habitual component preferably having an exponential distribution. As shown in FIG. 6, a Gaussian function 51 or other normal distribution is one example of a peaked distribution for representing the habitual component. A Delta function could also be used for the peaked distribution. Exponential function 52 represents the non-habitual component. A composite function 54 obtained by summing functions 51 and 52 provides a model of individual trip chain distributions with the shape shown in FIG. 7. For each individual driver, the task becomes the proper placement of and relative magnitudes of the component functions.

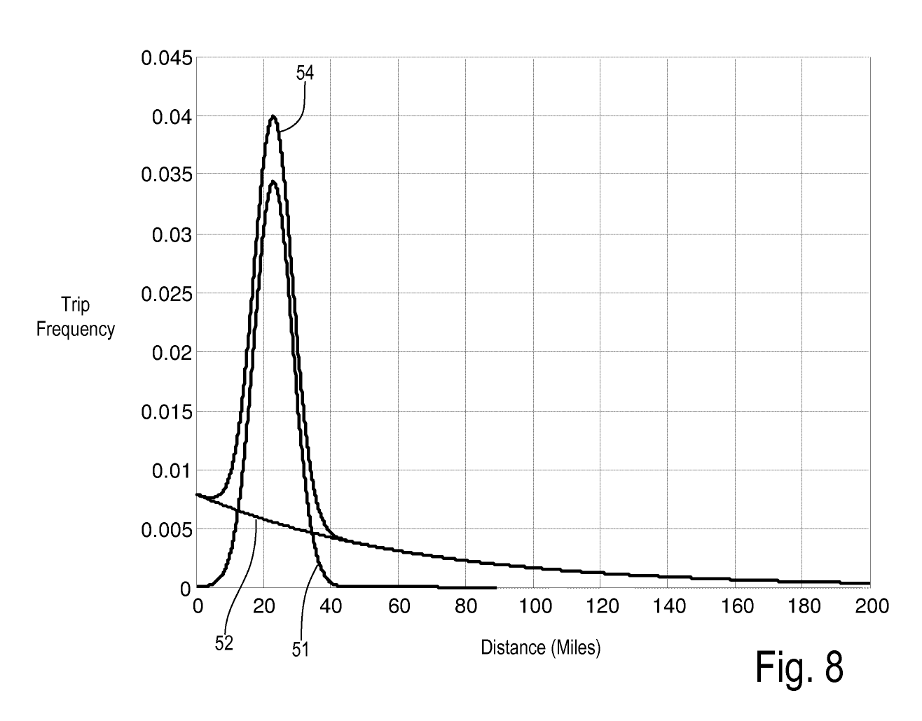

As shown in FIG. 6, habitual component 51 has a peak located at a distance μ and a width σ. Non-habitual component 52 is defined by a scale factor k such that component 52 has a maximum at 1/k. The relative importance of habitual to non-habitual driving of the individual driver is represented by a weight factor w and a frequency parameter λ which are used to combine the habitual and non-habitual components as described below. FIG. 8 shows components 51 and 52 and the resulting composite function 54. Once the composite function for an individual driver is determined, straightforward calculations are used to determine energy consumption for various scenarios and vehicles. The model and related calculations are discussed in greater detail below.

The parameters for calibrating the composite function for the ITCDs of a user the peak parameter μ, the width parameter σ, the frequency parameter λ, the weight factor w, and the scale factor k. The user's answer to the question “how many days per week do you commute” is designated as the commute repetition X₁. The user's answer to the question “what is your round trip commute distance” is designated as the commute distance X₂. The user's answer to the question “what is your total annual mileage driven” is designated as the long-term aggregate driving distance X₃. The user's answer to the question “how many days per year do you driver your car” is designated as the daily usage rate X₄. The parameters are calculated from the user's answers as follows:

μ=X₂

σ=min(X₂/5,7.5)

λ=X₄/365

w=(X₃−52X₂X₁)/X₃

k=X₃/(365λw)−(1−w)μ/w

Thus, the location of the peak of the habitual component is determined by the commute round-trip distance. The width a of the peak is set to one-fifth of the value of μ unless μ is larger than 37.5, in which case σ is set to 7.5 so that the modeled ITCDs maintain a sufficient proportion of habitual driving.

More specifically, a composite ITCD function designated p(x) is as follows:

$$p ( x ) = \frac{w}{k} {e}^{- x / k} + ( 1 - w ) \frac{1}{\sqrt{2 {πσ}^{2}}} {e}^{- {( x - μ )}^{2} / 2 {σ}^{2}} \qquad [ Equation 1 ]$$

The calculated parameters define a composite function for the ITCDs that estimates the driving behavior of the individual user. With the estimated ITCDs, the gasoline fuel consumption and/or any other energy consumption can be calculated based on the capabilities and assumptions associated with the various vehicle models and types that are configured for the analysis. In general, the energy consumption for a vehicle can be found using the following equations.

$$\begin{matrix}〈 {E}_{F}^{ND} 〉 = λ {\int }_{0}^{∞} {γ}_{F}^{S} x ( \frac{w}{k} {e}^{- x / k} + ( 1 - w ) \frac{1}{\sqrt{2 {πσ}^{2}}} {e}^{- {( x - μ )}^{2} / 2 {σ}^{2}} ) d x & [ Equation 2 ] \\ 〈 {E}_{F} 〉 = λ {\int }_{0}^{R} {γ}_{F}^{D} x ( \frac{w}{k} {e}^{- x / k} + ( 1 - w ) \frac{1}{\sqrt{2 {πσ}^{2}}} {e}^{- {( x - μ )}^{2} / 2 {σ}^{2}} ) d x + λ {\int }_{R}^{∞} ( {γ}_{F}^{S} x - \frac{{E}_{PI} {η}_{E}}{{η}_{F}} ) ( \frac{w}{k} {e}^{- x / k} + ( 1 - w ) \frac{1}{\sqrt{2 {πσ}^{2}}} {e}^{- {( x - μ )}^{2} / 2 {σ}^{2}} ) d x & [ Equation 3 ]\end{matrix}$$

where E_{F}^{ND} is the fuel energy consumption of a vehicle without a depletion phase (i.e., a vehicle without a battery to supply energy for part or all of the propulsion) and where E_{F} is fuel energy consumption of a vehicle with a depletion phase characterized by a depletion range related to a usable battery capacity E as follows:

$$R = \frac{{E}_{PI}}{{γ}_{E}^{D}} \qquad [ Equation 4 ]$$

The rate of fuel energy consumption for a particular vehicle during the battery depletion phase is designated γ_{F}^{D}, and the rate of electrical energy consumption for the vehicle during the battery depletion phase is designated γ_{E}^{D}. The rate of fuel energy consumption during a sustaining phase wherein a hybrid vehicle operates with no net contribution from the battery is designated γ_{F}^{S}. These rates are programmed into the analyzer for each vehicle to be compared. Using the programmed rates and the calculated parameters, the annual fuel usage for the selected vehicles are calculated and the fuel savings are displayed.

A more detailed alternative energy consumption model could optionally be used in which there are two basic types of driving: highway driving and city driving. The fraction of highway vs. city driving is generally a function of the length of the trip. Shorter trips tend to have a larger fraction of city miles than longer trips. Based on empirical data, the fraction of highway miles increases from zero for short trips approximately linearly up to some trip length and then saturates at a more or less constant fraction of highway miles at about 70%. This can be approximated with a piece-wise linear function. For trip chains less than a saturation distance (xₛ), the fraction of highway miles is given by φ=xφₛ/xₛ. For trip chains greater than the saturation distance, the fraction of highway miles is φ=φₛ. For both the city and highway cycles, the vehicle requires a certain amount of energy to sustain the cycle. The vehicle energy required for highway driving is εᵥₑₕ^{H} and for city driving is εᵥₑₕ^{C}. The amount of energy required by the vehicle is independent of whether that energy is supplied by on-board fuel or electrical energy from the battery. What changes when switching from fuel energy to electrical energy is the efficiency of the propulsion system to convert the stored energy into kinetic energy for the vehicle. The efficiency of converting fuel energy to kinetic energy is η_{F} and the efficiency of converting energy stored in the battery to kinetic energy is η_{E}.

Each trip chain is divided into two segments. The first segment is the depletion phase. During this phase the vehicle uses plug-in energy stored in the battery if possible. Because of various design constraints in the vehicle, it may not be possible to use purely electric drive during the depletion phase. If this is the case, the vehicle will be operating in a blended operating mode in which some fraction of the vehicle energy is provided by electric energy and the rest is provided by fuel. This fraction is called the electrification fraction. In general, there will be a different electrification fraction for city (f_{CE}) and highway (f_{HE}) driving.

If a trip chain is long enough, the battery charge will be depleted to the point that it is no longer possible to use energy from the battery. Once the battery has been depleted, the vehicle shifts into a charge sustaining mode. In this mode all energy comes from fuel. To calculate the average of the fuel energy and electrical energy consumed over a distribution of drive distances, the energy consumption rate by the vehicle during these two phases is needed. For the charge-sustaining phase, a fuel consumption number for city driving and highway driving are needed. For the depletion phase, fuel consumption and electrical consumption for both city and highway driving are needed. An approximation of these relationship is given by:

$${γ}_{CF}^{S} = \frac{{ɛ}_{veh}^{C}}{{η}_{F}} \\ {γ}_{HF}^{S} = \frac{{ɛ}_{veh}^{H}}{{η}_{F}} \\ {γ}_{CF}^{D} = \frac{{ɛ}_{veh}^{C}}{{η}_{F}} ( 1 - {f}_{CE} ) \\ {γ}_{HF}^{D} = \frac{{ɛ}_{veh}^{H}}{{η}_{F}} ( 1 - {f}_{HE} ) \\ {γ}_{CE}^{D} = \frac{{ɛ}_{veh}^{C}}{{η}_{E}} {f}_{CE} \\ {γ}_{H E}^{D} = \frac{{ɛ}_{veh}^{H}}{{η}_{E}} {f}_{HE} \qquad [ Equation 5 ]$$

The distance the vehicle can travel during the depletion phase is referred to as the plug-in range of the vehicle. Letting E_{PI} be the energy available in a fully charged is battery, the plug in range (R) is determined by setting the electric energy consumption equal to E_{PI} and solving for R. This gives the following two expressions:

$$R = \frac{{γ}_{CE}^{D} + \sqrt{{( {γ}_{CE}^{D} )}^{2} + 4 \frac{{ϕ}_{s}}{{x}_{s}} ( {γ}_{HE}^{D} - {γ}_{CE}^{D} ) {E}_{PI}}}{2 \frac{{ϕ}_{s}}{{x}_{s}} ( {γ}_{HE}^{D} - {γ}_{CE}^{D} )} ; R < {x}_{s} \\ R = \frac{{E}_{PI}}{( {γ}_{HE}^{D} - {γ}_{CE}^{D} ) {ϕ}_{s} + {γ}_{CE}^{D}} ; R > {x}_{s} \qquad [ Equation 6 ]$$

For trip chains longer than the depletion range, the energy consumed per unit distance driven is the energy consumption in charge sustaining mode minus the energy offset during charge sustaining mode divided by the total trip chain length. So, the fuel energy consumption per unit distance driven for trip chains less than the plug-in range is ε_{F}(x)=γ_{HF}^{D}φ(x)+γ_{CF}^{D}(1−φ(x)), and for trip chains longer than the plug-in range then energy consumption is

$${ɛ}_{F} ( x ) = {γ}_{HF}^{S} φ ( x ) + {γ}_{CF}^{S} ( 1 - ϕ ( x ) ) - \frac{{E}_{PI} {η}_{E}}{x {η}_{F}} \qquad [ Equation 7 ]$$

The electrical consumption for trip chains less than plug-in range is ε_{E}(x)=γ_{HE}^{D}φ(x)+γ_{CE}^{D}(1−φ(x)). For trip chains longer than the plug-in range, the electrical energy consumed per unit distance driven is the usable capacity of the battery divided by the trip chain length, namely ε_{E}(x)=E_{PI}/x.

To calculate fuel-offset due to charge-depleting operation, the amount of fuel used by vehicles operating only in charge sustaining mode is first calculated. Then the fuel energy used if the vehicle uses energy from the battery in a charge depleting mode is calculated. From these two numbers, the percent of fuel energy that is offset by the plug-in operation is determined. For completeness, a calculation of the electrical energy consumed is completed.

The average fuel energy consumed per trip chain in the absence of a charge depleting mode is:

$$\begin{matrix}〈 {E}_{F}^{ND} 〉 = {\int }_{0}^{∞} x {ɛ}_{F} ( x ) f ( x ) d x \\ = {\int }_{0}^{{x}_{s}} [ {γ}_{HF}^{S} \frac{{φ}_{s}}{{x}_{s}} x + {γ}_{CF}^{S} ( 1 - \frac{{φ}_{s}}{{x}_{s}} x ) ] xf ( x ) d x + \\ {\int }_{{x}_{s}}^{∞} [ {γ}_{HF}^{S} {φ}_{s} + {γ}_{CF}^{S} ( 1 - {φ}_{s} ) ] xf ( x ) d x\end{matrix} \qquad [ Eq . 8 ]$$

To calculate the energy consumption with depletion it becomes necessary to consider two cases: the case when the plug-in range of the vehicle is larger than the distance at which the highway driving fraction saturates, and the case when the plug-in range is less than the saturation distance. In practice, the plug-in range will almost certainly be less than the saturation distance. For completeness, both cases are discussed.

For the case that R<xₛ, the average fuel energy consumed in a charge depleting mode is:

$$〈 {E}_{F} 〉 = {\int }_{0}^{R} [ {γ}_{HF}^{D} \frac{{φ}_{s}}{{x}_{s}} x + {γ}_{CF}^{D} ( 1 - \frac{{φ}_{s}}{{x}_{s}} x ) ] xf ( x ) d x + {\int }_{R}^{{x}_{s}} [ {γ}_{HF}^{S} \frac{{φ}_{s}}{{x}_{s}} x + {γ}_{CF}^{S} ( 1 - \frac{{φ}_{s}}{{x}_{s}} x ) ] xf ( x ) d x + {\int }_{{x}_{s}}^{∞} [ {γ}_{HF}^{S} {φ}_{s} + {γ}_{CF}^{S} ( 1 - {φ}_{s} ) ] xf ( x ) d x - {\int }_{R}^{∞} \frac{{E}_{PI} {η}_{E}}{{η}_{F}} f ( x ) d x \qquad [ Equation 9 ]$$

In Equation 8, the first term is the integral taken up to the plug-in range of the vehicle. In this term, the fuel energy consumption for charge depletion in city and highway driving can be averaged. In the second term, the integration is from the plug-in range up to the saturation distance. In this term, the fuel energy consumption is switched to the charge sustaining values while continuing to use a linearly increasing expression for the fraction of highway miles driven. The third integral represents the charge sustaining operation above the saturation distance. In this term, the charge sustaining fuel consumption numbers and a constant fraction of highway miles driven are used. The fourth term is an energy offset due to depletion of the battery.

For the case that R>xₛ, the average fuel energy consumed in charge depletion is:

$$〈 {E}_{F} 〉 = {\int }_{0}^{{x}_{s}} [ {γ}_{HF}^{D} \frac{{φ}_{s}}{{x}_{s}} x + {γ}_{CF}^{D} ( 1 - \frac{{φ}_{s}}{{x}_{s}} x ) ] xf ( x ) d x + {\int }_{{x}_{s}}^{R} [ {γ}_{HF}^{D} {φ}_{s} + {γ}_{CF}^{D} ( 1 - {φ}_{s} ) ] xf ( x ) d x + {\int }_{R}^{∞} [ {γ}_{HF}^{S} {φ}_{s} + {γ}_{CF}^{S} ( 1 - {φ}_{s} ) ] xf ( x ) d x - {\int }_{R}^{∞} \frac{{E}_{PI} {η}_{E}}{{η}_{F}} f ( x ) d x \qquad [ Equation 10 ]$$

The difference in Equation 9 as compared to Equation 8 is a switch from a linearly increasing fraction of highway miles driven to a constant fraction of highway miles for the third integral, representing the charge sustaining operation.

To calculate the average electrical energy consumed, it is noted that electrical energy is consumed for propulsion only up to the electrified range of the vehicle. For any trip chain greater than this range, the entire plug-in capacity of the battery (E_{PI}) is used. So, for trip chains greater than the plug-in range, the grid energy consumed per unit distance driven is the capacity of the battery divided by the length of the trip chain.

With this in mind, the average grid energy consumed per unit distance driven for the case that R<xₛ is:

$$〈 {E}_{E} 〉 = {\int }_{0}^{R} [ {γ}_{HF}^{D} \frac{{φ}_{s}}{{x}_{s}} x + {γ}_{CF}^{D} ( 1 - \frac{{φ}_{s}}{{x}_{s}} x ) ] xf ( x ) d x + {\int }_{R}^{∞} {E}_{PI} f ( x ) d x \qquad [ Equation 11 ]$$

The average grid energy consumed for the case that R>xₛ is:

$$〈 {E}_{E} 〉 = {\int }_{0}^{{x}_{s}} [ {γ}_{HF}^{D} \frac{{φ}_{s}}{{x}_{s}} x + {γ}_{CF}^{D} ( 1 - \frac{{φ}_{s}}{{x}_{s}} x ) ] xf ( x ) d x + {\int }_{{x}_{s}}^{R} [ {γ}_{HF}^{D} {φ}_{s} + {γ}_{CF}^{D} ( 1 - {φ}_{s} ) ] xf ( x ) d x + {\int }_{R}^{∞} {E}_{PI} f ( x ) d x \qquad [ Equation 12 ]$$

For the case of an all-electric vehicle, the driving range is sufficiently large that the distance-dependent mix of surface and freeway driving does not apply, and a single rate of energy consumption can be used. For a given usable battery energy, electric range is then given by equation 4. For a given electric range, and the parameters extracted from the questionnaire, the of number days per year that the range R is inadequate to complete the desired trip chain is given by:

$$N ( R ) = 365 \times λ {\int }_{R}^{∞} ( \frac{w}{k} {e}^{- x / k} + ( 1 - w ) \frac{1}{\sqrt{2 {πσ}^{2}}} {e}^{- {( x - μ )}^{2} / 2 {σ}^{2}} ) d x \qquad [ Equation 13 ]$$

The energy comparison results may preferably report this number of days to the user whenever a vehicle being compared is a fully electric, non-hybrid vehicle.

What is claimed is:

1. A benefit analysis system in which a user compares energy consumption between a first electrified vehicle and a second vehicle, comprising:
a data collector receiving user driving characteristics comprised of a commute distance, a commute repetition, a long-term aggregate driving distance, and a daily usage rate;
a parameter calculation module receiving the user driving characteristics, wherein the parameter calculation module determines a peak parameter, a width parameter, a weigh factor, a scale factor, and a frequency parameter in response to the user driving characteristics; and
an analyzer responsive to the parameters from the parameter calculation module to generate respective energy consumption results for the first and second vehicles, wherein the analyzer represents an individual trip chain distribution as a composite function including a habitual component defined by the peak parameter and the width parameter and a non-habitual component defined by the scale factor, wherein the composite function combines the habitual component and the non-habitual component according to the weight factor, and wherein the analyzer determines the energy consumption results in response to the individual trip chain distributions.

2. The system of claim 1 wherein the peak parameter is proportional to the commute distance, wherein the width parameter is proportional to the commute distance, wherein the frequency parameter is proportional to the daily usage rate, wherein the weight factor is determined in response to the commute distance, the commute repetition, and the long-term aggregate driving distance, and wherein the scale factor is determined in response to the commute distance, the commute repetition, the long-term aggregate driving distance, and the daily usage rate.

3. The system of claim 2 wherein the commute distance is collected as a round trip distance, wherein the commute repetition is collected in days per week, wherein the long-term aggregate driving distance is collected in distance per year, and wherein the daily usage rate is collected in days per year.

4. The system of claim 2 wherein the parameters are determined as follows:
μ=X₂
σ=min(X₂/5,7.5)
λ=X₄/365
w=(X₃−52X₂X₁)/X₃
k=X₃/(365λw)−(1−w)μ/w
where μ is the peak parameter, σ is the width parameter, λ is the frequency parameter, w is the weight factor, k is the scale factor, X₁ is the commute distance, X₂ is the commute repetition, X₃ is the long-term aggregate driving distance, and X₄ is the daily usage rate.

5. The system of claim 4 wherein the individual trip chain distribution p(x) is represented by:
$$p ( x ) = \frac{w}{k} {e}^{- x / k} + ( 1 - w ) \frac{1}{\sqrt{2 {πσ}^{2}}} {e}^{- {( x - μ )}^{2} / 2 {σ}^{2}} .$$

6. The system of claim 1 wherein the habitual component is comprised of a normal distribution and the non-habitual component is comprised of an exponential distribution.

7. The system of claim 1 wherein the second vehicle is powered by a combustion engine.

8. The system of claim 1 wherein the first and second vehicles are electric vehicles powered by a respective battery.

9. The system of claim 1 wherein the first vehicle is a hybrid electric vehicle powered by both a combustion engine and a battery.

10. The system of claim 9 wherein the second vehicle is a hybrid electric vehicle powered by both a combustion engine and a battery.

11. The system of claim 1 wherein the energy consumption results are comprised of an annual fuel savings of one of the first or second vehicles over the other.

12. The system of claim 1 wherein the energy consumption results include a number of days for which an individual trip chain distribution exceeds an electric range of one of the first or second vehicles.

13. A method of comparing energy consumption between a first electrified vehicles and a second vehicle in response to characteristics of a driver, comprising the steps of:
the driver specifying a commute distance, a commute repetition, a long-term aggregate driving distance, and a daily usage rate;
determining a peak parameter, a width parameter, a weigh factor, a scale factor, and a frequency parameter in response to the user driving characteristics;
represents an individual trip chain distribution for the driver as a composite function including a habitual component defined by the peak parameter and the width parameter and a non-habitual component defined by the scale factor, wherein the composite function combines the habitual component and the non-habitual component according to the weight factor;
determining an energy consumption for each of the first and second vehicles in response to the individual trip chain distributions; and
presenting the energy consumptions to the driver for evaluating the relative benefits of driving the first and second vehicles.

14. The method of claim 13 wherein the peak parameter is proportional to the commute distance, wherein the width parameter is proportional to the commute distance, wherein the frequency parameter is proportional to the daily usage rate, wherein the weight factor is determined in response to the commute distance, the commute repetition, and the long-term aggregate driving distance, and wherein the scale factor is determined in response to the commute distance, the commute repetition, the long-term aggregate driving distance, and the daily usage rate.

15. The method of claim 14 wherein the commute distance is collected as a round trip distance, wherein the commute repetition is collected in days per week, wherein the long-term aggregate driving distance is collected in distance per year, and wherein the daily usage rate is collected in days per year.

16. The method of claim 14 wherein the parameters are determined as follows:
μ=X₂
σmin(X₂/5,7.5)
λ=X₄/365
w=(X₃−52X₂X₁)/X₃
k=X₃/(365λw)−(1−w)μ/w
where μ is the peak parameter, σ is the width parameter, λ is the frequency parameter, w is the weight factor, k is the scale factor, X₁ is the commute distance, X₂ is the commute repetition, X₃ is the long-term aggregate driving distance, and X₄ is the daily usage rate.

17. The method of claim 16 wherein the individual trip chain distribution p(x) is represented by:
$$p ( x ) = \frac{w}{k} {e}^{- x / k} + ( 1 - w ) \frac{1}{\sqrt{2 {πσ}^{2}}} {e}^{- {( x - μ )}^{2} / 2 {σ}^{2}} .$$

18. The method of claim 13 wherein the habitual component is comprised of a normal distribution and the non-habitual component is comprised of an exponential distribution.

19. The method of claim 13 wherein the second vehicle is powered by a combustion engine.

20. The method of claim 13 wherein the first and second vehicles are electric vehicles powered by a respective battery.

21. The method of claim 13 wherein the first vehicle is a hybrid electric vehicle powered by both a combustion engine and a battery.

22. The method of claim 21 wherein the second vehicle is a hybrid electric vehicle powered by both a combustion engine and a battery.

23. The method of claim 13 wherein the energy consumption results are comprised of an annual fuel savings of one of the first or second vehicles over the other.

24. The method of claim 13 wherein the energy consumption results include a number of days for which an individual trip chain distribution exceeds an electric range of one of the first or second vehicles.
